(19) United States
(12) Patent Application Publication
(10) Pub. No.: US 2005/0035866 A1
(43) Pub. Date: Feb. 17, 2005

(54) Safety device

(76) Inventors: Robin Christopher Hatherell, Glynneath (GB); Deborah Louise Walker, Glynneath (GB)

Correspondence Address: WADDEY & PATTERSON, 414 UNION STREET, SUITE 2020, BANK OF AMERICA PLAZA, NASHVILLE, TN, 37219, US

(21) Appl. No.: 10/482,195

(22) PCT Filed: Jun. 10, 2002
(86) PCT No.: PCT/GB02/02619

(30) Foreign Application Priority Data
Jun. 13, 2001 (GB) 0114380.9
Jan. 11, 2002 (GB) 0200627.8

(51) Int. Cl. G08B 23/00

(52) U.S. Cl. 340/573.6

(57) ABSTRACT

A water safety device comprises a sub-surface pressure sensing consisting of a piezo electric transducer (1) located between a sealed chamber (4) and an open chamber (2) that allows water to enter through vents (3). Changes in water pressure will result in a flexing of the piezo electric transducer providing a detectable output to the processor unit (9). The safety device also analyses surface wave motion. A ball (8) is housed within a half sphere vessel (6) that has a rough inner surface. A pimple (7) prevents the ball from remaining stationary. The half sphere vessel (6) has a lid to retain the ball within the “motion detector”. As the floating detection module rocks with the waves the ball (8) will move within the half sphere vessel (6) creating vibrations due to the rough inner surface. These vibrations are sympathy with the wave motion and are detected by the piezo electric transducer (5) located in the base of the “motion detector” within the sealed chamber (4). The piezo electric transducer (5) creates an output to the processor unit (9). The processor algorithm determines the state of alarm by constantly analysing both inputs from the two separate detectors (1,5). In this case, vibrations detected using the above-mentioned second detection method will only trigger an alarm state if a change of water pressure has also been detected by the piezo electric transducer and registered.

This invention relates to a safety device and, more particularly, to a safety device for use in detecting and indicating the introduction and/or presence of a foreign body within a body of liquid.

There are many circumstances in which it may be desirable or necessary to provide a safety device for a body of liquid, such as a pond or swimming pool for example, to detect and indicate that a foreign body has been introduced into, or is otherwise present, in the water. In particular, it may be highly desirable to provide a safety device for a body of water such as a swimming pool or pond which can detect and indicate quickly and reliably that a small child or animal may have fallen into it.

Swimming pool alarms are available which detect, for example, vibrations within the body of liquid and activate an alarm or the like in the event that such vibrations are detected. However, such devices are often unreliable because they can easily be triggered to enter the alarm state by vibrations caused by, for example, wind or surface turbulence caused by other external factors which are not related to a person or animal falling into the swimming pool. Such alarms also often rely on someone activating or setting them before every use.

We have now devised an arrangement which overcomes the problems outlined above.

Thus, in accordance with the present invention, there is provided a safety device for detecting the introduction and/or presence of a foreign body or object in or on a body of liquid, the safety device comprising first detection means for detecting a first parameter indicating the possible introduction and /or presence of a foreign body or object in or on said body of liquid, second detection means for detecting a second parameter indicating the possible introduction and/or presence of a foreign body in said body of liquid, and means for indicating the introduction and/or presence of a foreign body or object in said body of liquid only in the event that at least both said first and second parameters are detected by said first and second detection means respectively.

In one preferred embodiment of the invention, the first parameter may comprise underwater pressure change with respect to the body of liquid. The second parameter may comprise surface motion or vibration of the liquid. In this case, therefore, unless the device has already detected a change of underwater pressure, then surface vibration alone will not trigger the indicating means.

When the indicating means is triggered, it is preferably arranged to transmit an indicator signal (via radio wave transmission or the like) to one or more remote alarm units which emit an alarm signal (whether audible or otherwise) in response to receipt of the indicator signal to alert a third party of the possible presence of a person or animal in the body of liquid. It may in addition (or alternatively) be arranged to emit an alarm signal locally.

The underwater pressure change may be detected by any suitable means, beneficially one or more piezo electric transducers or the like. In this case, the device preferably comprises a unit having a sealed chamber and means for allowing liquid from the body of liquid to enter the unit. The piezo electric transducer (or transducers) are preferably located between the sealed chamber and the liquid from the body of liquid. Changes in liquid pressure will result in a flexing of the piezo electric transducer providing a detectable output to a processor unit or the like.

Another piezo electric transducer may be utilised within a vibration or motion detection means. Such detection means may consist of a half sphere vessel with a rough inside surface and a pimple positioned at its lowest point. This vessel contains a free moving ball or the like that causes vibrations as it runs over the rough surface (as a result of surface wave motion). The piezo electric transducer flexes as a result of such vibrations and consequently provides a detectable output to a processor or the like. The “motion detector” is beneficially located within the above-mentioned sealed chamber.

The safety device may be made of UV chlorine and algae stabilised plastic, which is available in a variety of colours. A solar cell may be located at the top of the device to allow a trickle charge to the battery ensuring efficient operation. A radio transmitter is preferably located may be powered by a means source with a battery back-up receives the alarm signal. Within the receiver may be a piezo sounder, or the like, which is activated on receiving an alarm signal from the transmitter. The transmitter may have the ability to send a low battery warning to the receiver that subsequently emits an intermittent beep. A piezo sounder is preferably activated within the detection unit when it is in an alarm state.

An exemplary embodiment of the present invention will now be described by way of example only and with reference to the accompanying drawings, in which:

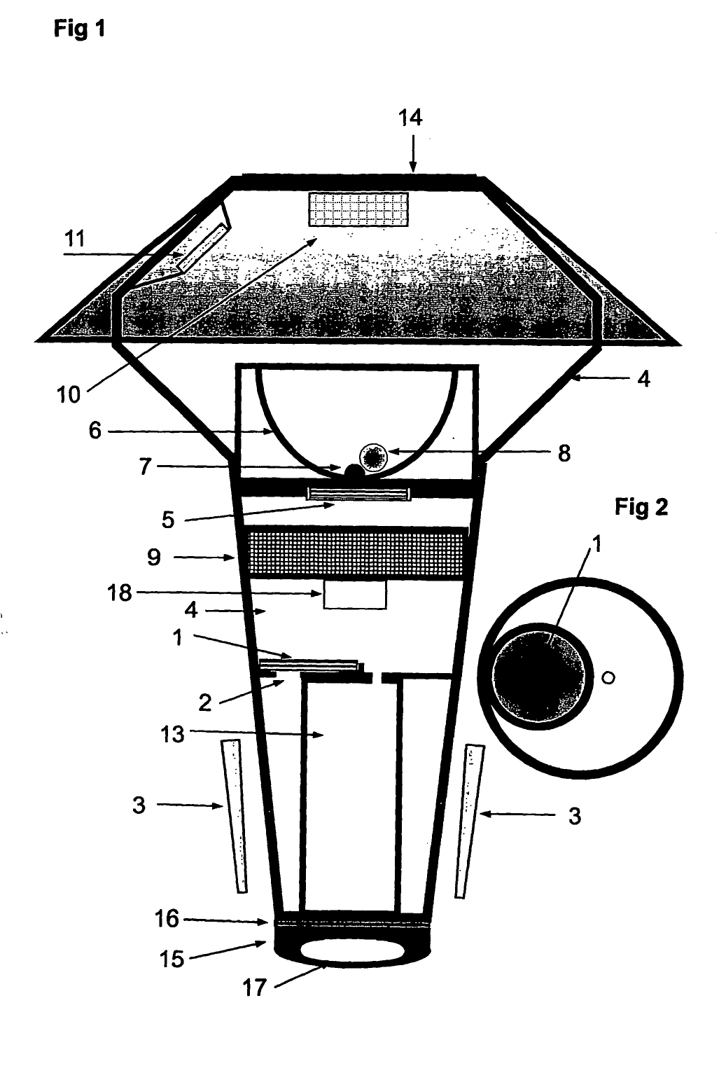

FIG. 1 is a cross-sectional front view of a safety device according to an exemplary embodiment of the present invention;

FIG. 2 is a plan view of the dividing wall separating the sealed chamber and the open chamber of the safety device of FIG. 1;

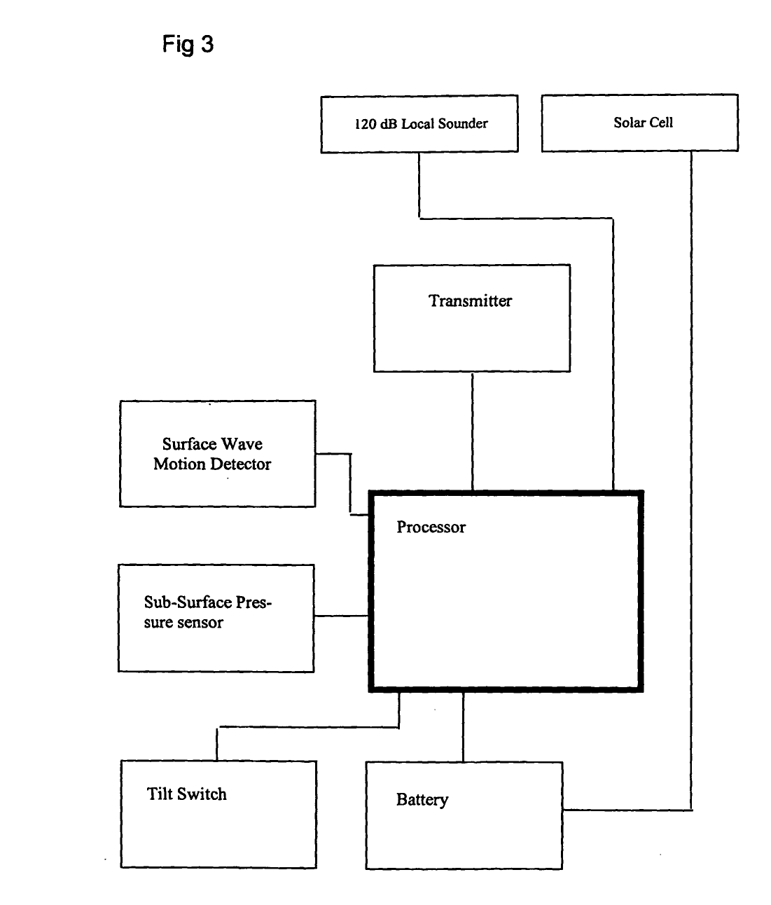

FIG. 3 is a schematic block diagram of a safety device according to an exemplary embodiment of the present invention;

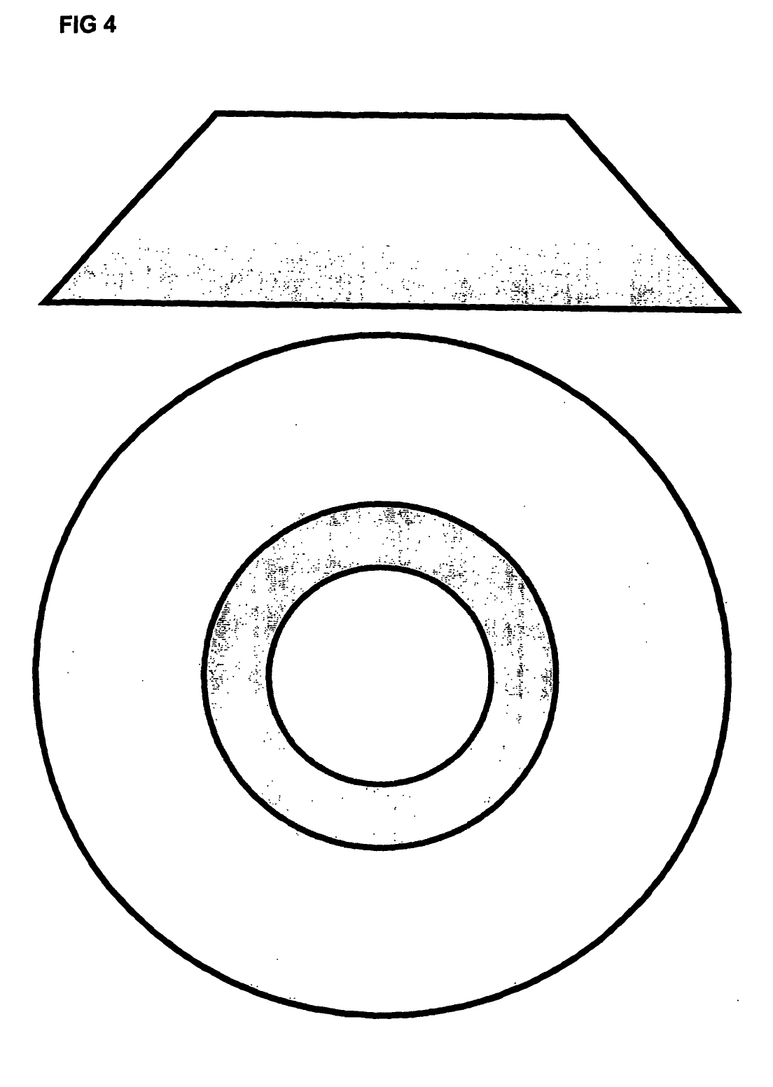

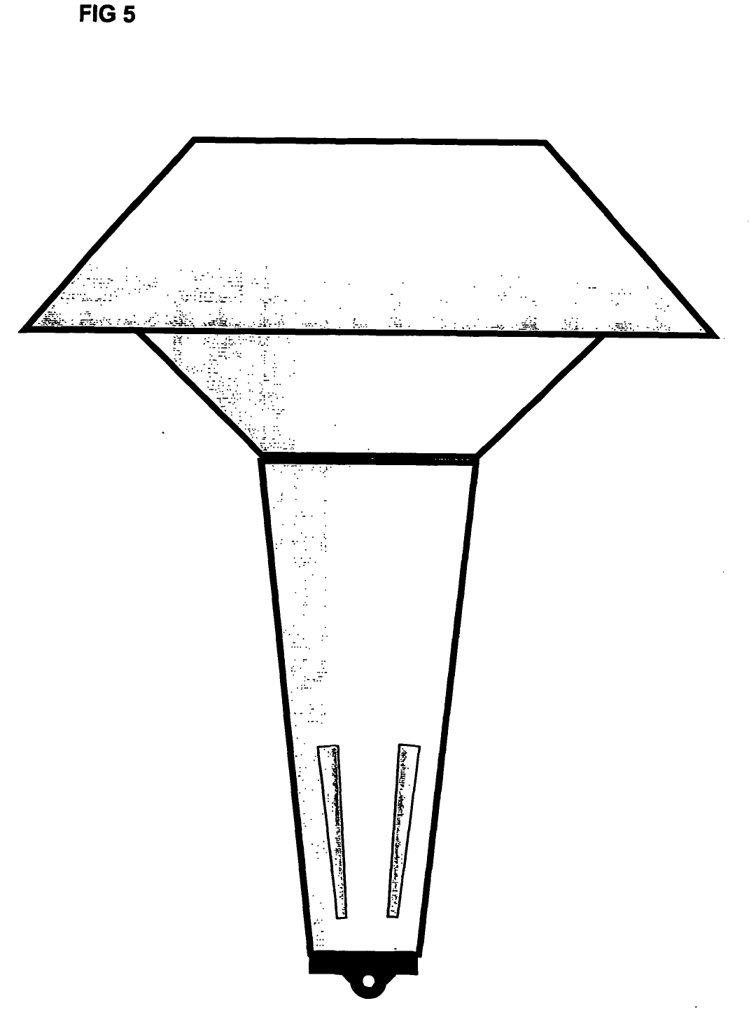

FIG. 4 is a plan view of the housing of the safety device of FIG. 1;

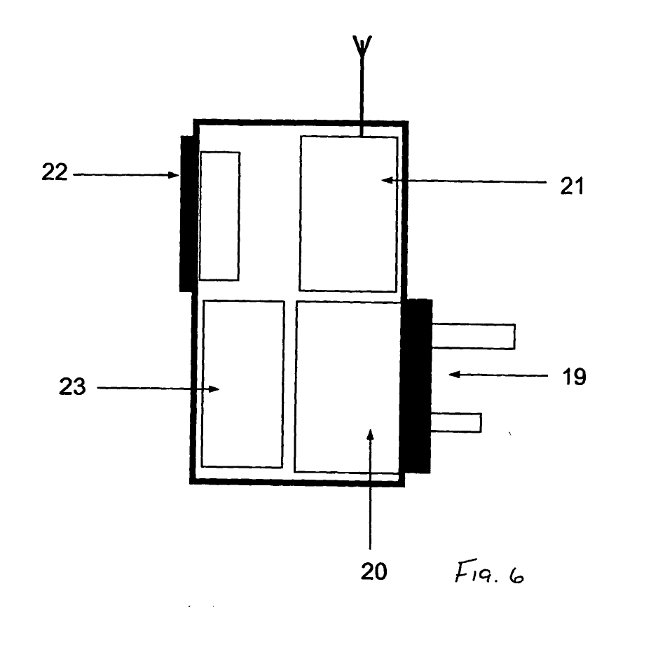

FIG. 5 is a side view of the housing of the safety device of FIG. 1; and

FIG. 6 is a schematic diagram of a mains powered wireless receiver and sounder unit for use with the safety device of FIG. 1.

Water safety device according to an exemplary embodiment of the present invention comprises a sub-surface pressure sensor consisting of a piezo electric transducer 1 located between a sealed chamber 4 and an open chamber 2 that allows water to enter through vents 3. Changes in water pressure will result in a flexing of the piezo electric transducer providing a detectable output to the processor unit 9.

The second detection method used in this exemplary embodiment of the invention analyses surface wave motion. A ball 8 is housed within a half sphere vessel 6 that has a rough inner surface. A pimple 7 prevents the ball from remaining stationary. The half sphere vessel 6 has a lid to retain the ball within the “motion detector”. As the floating detection module rocks with the waves the ball 8 will move within the half sphere vessel 6 creating vibrations due to the rough inner surface. These vibrations are sympathy with the wave motion and are detected by the piezo electric transducer 5 located in the base of the “motion detector” within the sealed chamber 4. The piezo electric transducer 5 creates an output to the processor unit 9.

The processor algorithm determines the state of alarm by constantly analysing both inputs from the two separate detectors (1,5). In this case, vibrations detected using the above-mentioned second detection method will only trigger an alarm state if a change of water pressure has also been detected by the piezo electric transducer and registered.

When the processor 9 determines an alarm state an output is generated to activate the wireless transmitter 10 and the piezo sounder 11. The wireless transmitter 10 sends a signal to a wireless receiver 23 that then creates an alarm. The piezo sounder 11 is activated creating an alarm local to the floating detection module.

A battery that is housed within a watertight chamber 13 powers to floating detection module. In one embodiment of the invention this battery can be charged via a solar cell 14. Access to the watertight chamber 13 is gained via a secured cover 15 and a watertight gasket 16. This cover also has a securing point 17 that is used to ensure the floating detection module remains in the same area of the pool or pond.

FIG. 6 illustrates a wireless receiver and sounder unit for use with a safety device according to an exemplary embodiment of the invention. The unit connects into any mains socket via the plug 19; the type varies depending upon local country standards. A power supply controller 20 located within the module constantly monitors the receiver 21 to ensure that the sounder 22 is activated immediately when an alarm signal from the floating detection module transmitter 10 is received. A standby battery 23 ensures operation will continue during short power outages.

The floating detection module of a safety device according to the present invention can preferably be switched off when the pool/pond is in use by turning the unit battery upside down. This operates a tilt switch 18 that disconnects the power from the battery.

Note:
1. Due to a wide variety of environments within which this unit could be used, the half sphere vessel 6 of the “motion detector” may vary in shape in order to increase or decrease sensitivity.
2. The safety device of the invention could be made available in a variety of configurations, for example:
   (a) motion detector, sub-surface pressure sensor and immersion sensor along with radio transmitter, radio receiver, processor, tilt switch, solar cell and piezo sounder may all be present or any number of the above may be utilised in a particular model;
   (b) The outer shell of the floating detection module may be in a variety of different shapes depending upon the buoyancy and stability required in different environments;
   (c) The wireless receiver module shown in FIG. 6 can also be powered by a battery in standby mode and can be used to activate a pager-type facility;
   (d) A wireless receiver module can also be located within a security alarm system.

An embodiment of the present invention has been described above by way of example only and it will be appreciated that modifications and variations can be made to the described embodiment without departing from the scope of the invention. It will be appreciated that the underlying concept of the device which employs at least two methods of detecting the possible presence of a foreign body in a body of water, both detection methods being preferably realised and housed within a single self-contained unit which may be arranged to float on the body of cooler, be submerged therein, suspended or otherwise mounted thereover or attached to the side thereof.

1. A safety device for detecting the introduction and/or presence of a foreign body or object in or on a body of liquid, the safety device comprising first detection means for detecting a first parameter indicating the possible introduction and/or presence of a foreign body or object in or on said body of liquid, second detection means for detecting a second parameter indicating the possible introduction and/or presence of a foreign body in said body of liquid, and means for indicating the introduction and/or presence of a foreign body or object in said body of liquid only in the event that at least both said first and second parameters are detected by said first and second detection means respectively.

2. A safety device according to claim 1, wherein the first parameter comprises underwater pressure change with respect to the body of liquid.

3. A safety device according to claim 1, wherein the second parameter comprises surface motion or vibration of the liquid.

4. A safety device according to claim 1, wherein the indicating means is arranged to transmit an indicator signal (via radio wave transmission or the like) to one or more remote alarm units which emit an alarm signal (whether audible or otherwise) in response to receipt of the indicator signal to alert a third party of the possible introduction to and/or presence of a foreign body in the body of liquid.

5. A safety device according to claim 1, wherein the indicating means is arranged to emit an alarm signal locally.

6. A safety device according to claim 2, wherein the underwater pressure change is detected by one or more piezo electric transducers, or the like.

7. A safety device according to claim 3, wherein the surface motion or vibration of the liquid is detected by one or more piezo electric transducer.

8. A safety device according to claim 4, including a remote wireless receiver for receiving an alarm signal from the indicating means transmitter.

9. A safety device substantially as herein described with reference to the accompanying drawings.
